(19) United States
(12) Patent Application Publication
(10) Pub. No.: US 2004/0120085 A1
(43) Pub. Date: Jun. 24, 2004

(54) Semiconductor device with surge protection circuit

(75) Inventors: Fumitoshi Yamamoto, Hyogo (JP); Yasufumi Murai, Tokyo (JP); Keiichi Furuya, Hyogo (JP)

Correspondence Address: McDermott, Will & Emery, 600 13th Street, N.W., Washington, DC, 20005-3096, US

(73) Assignees: RENESAS TECHNOLOGY CORP.; KYOEI SANGYO CO., LTD.

(21) Appl. No.: 10/642,214

(22) Filed: Aug. 18, 2003

(30) Foreign Application Priority Data
Dec. 19, 2002 (JP) 2002-368456 (P)

(51) Int. Cl. H02H 9/00

(52) U.S. Cl. 361/56

(57) ABSTRACT

A semiconductor device with a surge protection circuit includes a surge protection circuit electrically connected to a signal input terminal and having an npn transistor and an npn transistor. The semiconductor device is configured such that the npn transistor is more susceptible to breakdown than the npn transistor, by implementing such a configuration that a narrowest region of a base of the npn transistor has a width different from that of a narrowest region of a base of the npn transistor. Thus, a semiconductor device with a surge protection circuit attaining a normal operation can be obtained.

### BACKGROUND OF THE INVENTION

1. Field of the Invention

The present invention relates to a semiconductor device, and more particularly to a semiconductor device with a surge protection circuit.

2. Description of the Background Art

A variety of devices have been proposed as a surge protection circuit for protecting, for example, a motor vehicle, a motor, a fluorescent display, audio apparatus, and an IC (Integrated Circuit) constituted with transistor devices or the like, from a current or voltage that has momentarily increased (a surge). A conventional surge protection circuit is disclosed in Japanese Patent Laying-Open No. 58-74081, for example.

According to a configuration disclosed in the above publication, the conventional surge protection circuit includes a lateral pnp transistor and a vertical npn transistor. A base and an emitter of the lateral pnp transistor and a collector of the vertical npn transistor are each electrically connected to an input terminal. The collector of the vertical npn transistor and the base of the lateral pnp transistor are formed with an identical n-type epitaxial layer. A collector of the lateral pnp transistor and a base of the vertical npn transistor are formed with an identical p-type impurity region formed within the n-type epitaxial layer. An emitter of the vertical npn transistor is formed with an n-type impurity region formed within the p-type impurity region.

Next, an operation of the surge protection circuit shown in the publication will be described. When a surge is applied to the input terminal, a depletion layer of a collector-base junction reaches a depletion layer of an emitter-base junction in the lateral pnp transistor, and punchthrough breakdown occurs. Accordingly, a current flows from the emitter to the collector. Since this current serves as a base current of the vertical npn transistor, the vertical npn transistor is electrically connected. Therefore, charges in the surge applied to the input terminal are released from the emitter side of the vertical npn transistor.

In addition, another surge protection circuit is disclosed in Japanese Patent Laying-Open No. 5-206385, and Japanese Patent Laying-Open No. 56-19657, for example.

In order to achieve a normal operation of the surge protection circuit shown in the above publications, the lateral pnp transistor should undergo breakdown at a voltage lower than that for the vertical npn transistor. In the configuration shown in the above publication, however, a voltage at which breakdown (hereinafter, referred to as a “withstand voltage”) occurs in the lateral pnp transistor may be higher than the withstand voltage of the vertical npn transistor. In such a case, the surge protection circuit does not achieve a normal operation.

Specifically, in the surge protection circuit shown in the above publications, a base region of the vertical npn transistor and a collector region of the lateral pnp transistor are formed with an identical region of an identical density (that is, an identical p-type impurity region). In addition, a collector region of the vertical npn transistor and a base region of the lateral pnp transistor are formed with an identical region of an identical density (that is, an identical n-type epitaxial layer). Therefore, because the depletion layer of the base-collector of the lateral pnp transistor has a thickness substantially similar to the depletion layer of the base-collector of the vertical npn transistor, tendency of avalanche breakdown is substantially similar, and the withstand voltage of the lateral pnp transistor is substantially similar to that of the vertical npn transistor. Accordingly, breakdown may occur in the lateral pnp transistor earlier than in the vertical npn transistor, which has made the operation of the surge protection circuit unstable.

### SUMMARY OF THE INVENTION

An object of the present invention is to provide a semiconductor device with a surge protection circuit attaining a normal operation.

A semiconductor device with a surge protection circuit according to one aspect of the present invention includes a surge protection circuit electrically connected to a signal input terminal and having a first transistor and a second transistor. The semiconductor device is configured such that the first transistor is more susceptible to breakdown than the second transistor, by implementing such a configuration that a narrowest region of a base of the first transistor has a width different from a narrowest region of a base of the second transistor.

Accordingly, a semiconductor device is obtained, which includes a surge protection circuit attaining a normal operation by implementing such a circuit configuration that, when a surge voltage is applied to the signal input terminal, a second transistor turns on by breakdown of a first transistor, and the surge voltage applied to the signal input terminal is released.

A semiconductor device with a surge protection circuit according to another aspect of the present invention includes a surge protection circuit electrically connected to a signal input terminal and having a first transistor and a second transistor. The semiconductor device is configured such that the first transistor is more susceptible to breakdown than the second transistor, by implementing such a configuration that a region attaining a function as the base of the first transistor has an impurity density different from a region attaining a function as the base of the second transistor.

Accordingly, a semiconductor device is obtained, which includes a surge protection circuit attaining a normal operation by implementing such a circuit configuration that, when a surge voltage is applied to the signal input terminal, a second transistor turns on by breakdown of a first transistor, and the surge voltage applied to the signal input terminal is released.

A semiconductor device with a surge protection circuit according to yet another aspect of the present invention includes a surge protection circuit electrically connected to a signal input terminal and having a first transistor and a second transistor. The semiconductor device includes a semiconductor substrate having a main surface, and a field oxide film formed on the main surface of the semiconductor substrate. An emitter of the first transistor and a collector of the second transistor are electrically connected to the signal input terminal. A collector of the first transistor and a base of the second transistor are formed so as to have the same conductivity type, and electrically connected to each other. A base of the first transistor is electrically connected to the emitter of the first transistor and the collector of the second transistor. A pn junction of the emitter and the base of the first transistor is in contact with one end of the field oxide film, and a pn junction of the collector and the base is in contact with the other end of the field oxide film.

Accordingly, a width of the base of the first transistor can freely be controlled by the field oxide film. Therefore, by making the width of the base of the first transistor smaller than that of the base of the second transistor, a configuration in which the first transistor is more susceptible to punchthrough breakdown than the second transistor can easily be implemented.

A semiconductor device with a surge protection circuit according to yet another aspect of the present invention includes a surge protection circuit electrically connected to a signal input terminal and having a first transistor and a second transistor. The semiconductor device includes a semiconductor substrate having an epitaxial layer of a first conductivity type on a main surface. An emitter of the first transistor and a collector of the second transistor are electrically connected to the signal input terminal. A collector of the first transistor and a base of the second transistor are formed to have the same conductivity type, and formed with a common, first diffusion region of a second conductivity type. A base of the first transistor is electrically connected to the emitter of the first transistor and the collector of the second transistor. A base of the first transistor surrounds the emitter of the first transistor, and includes a second diffusion region of a first conductivity type having an impurity density higher than the epitaxial layer. The first diffusion region and the second diffusion region are provided adjacent to each other on a main surface within the epitaxial layer.

Accordingly, the second diffusion region serving as the base of the first transistor is formed with a region of one conductivity type, and the first diffusion region serving as the base of the second transistor is formed with a region of an opposite conductivity type. Therefore, when the width of the base of the first transistor is made smaller than that of the base of the second transistor, the first transistor is configured so as to be more susceptible to punchthrough breakdown than the second transistor. In addition, when the base of the first transistor has an impurity density higher than the base of the second transistor, the first transistor is configured so as to be more susceptible to avalanche breakdown than the second transistor.

It is to be noted that, in the present specification, a region attaining a function as a base refers to an impurity diffusion region constituting a pn junction with each of an impurity diffusion region constituting an emitter and an impurity diffusion region constituting a collector, among impurity diffusion regions constituting the base.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram showing a surge protection circuit in Embodiment 1 of the present invention.

FIG. 2 is a plan view schematically showing a configuration of the surge protection circuit in Embodiment 1 of the present invention.

FIG. 3 is a cross-sectional view along the line III-III in FIG. 2.

FIG. 4 is a cross-sectional view schematically showing a configuration of a semiconductor device with a surge protection circuit in Embodiment 2 of the present invention.

FIG. 5 is a circuit diagram showing a surge protection circuit in Embodiment 3 of the present invention.

FIG. 6 is a plan view schematically showing a configuration of a semiconductor device with the surge protection circuit in Embodiment 3 of the present invention.

FIG. 7 is a cross-sectional view along the line VII-VII in FIG. 6.

FIG. 8 is a cross-sectional view schematically showing a configuration of a semiconductor device with a surge protection circuit in Embodiment 4 of the present invention.

FIG. 9 is a cross-sectional view schematically showing a configuration of a semiconductor device with a surge protection circuit in Embodiment 5 of the present invention.

FIG. 10 is a plan view schematically showing a configuration of a semiconductor device with a surge protection circuit in Embodiment 6 of the present invention.

FIG. 11 is a cross-sectional view along the line XI-XI in FIG. 10.

FIG. 12 is a cross-sectional view schematically showing a configuration of a semiconductor device with a surge protection circuit in Embodiment 7 of the present invention.

FIG. 13 is a plan view schematically showing a configuration of a semiconductor device with a surge protection circuit in Embodiment 8 of the present invention.

FIG. 14 is a cross-sectional view along the line XIV-XIV in FIG. 13.

FIG. 15 is a plan view schematically showing a configuration of a semiconductor device with a surge protection circuit in Embodiment 9 of the present invention.

FIG. 16 is a cross-sectional view along the line XVI-XVI in FIG. 15.

FIG. 17 is a circuit diagram showing a surge protection circuit in Embodiment 10 of the present invention.

FIG. 18 is a cross-sectional view schematically showing a configuration of a semiconductor device with the surge protection circuit in Embodiment 10 of the present invention.

FIG. 19 is a cross-sectional view schematically showing a configuration of a semiconductor device with a surge protection circuit in Embodiment 11 of the present invention.

FIG. 20 is a cross-sectional view schematically showing a configuration of a semiconductor device with a surge protection circuit in Embodiment 12 of the present invention.

FIG. 21 is a circuit diagram showing a surge protection circuit in Embodiment 13 of the present invention.

FIG. 22 is a plan view schematically showing a configuration of a semiconductor device with the surge protection circuit in Embodiment 13 of the present invention.

FIG. 23 is a cross-sectional view along the line XXIII-XXIII in FIG. 22.

FIG. 24 is a cross-sectional view schematically showing a configuration of a semiconductor device with a surge protection circuit in Embodiment 14 of the present invention.

### DESCRIPTION OF THE PREFERRED EMBODIMENTS

In the following, embodiments of the present invention will be described with reference to the figures.

(Embodiment 1)

Referring to FIG. 1, a surge protection circuit 51 includes an npn transistor 32 and an npn transistor 33. A collector of npn transistor 32 and a collector of npn transistor 33 are electrically connected to a signal input terminal 34 and a device portion 36. A base of npn transistor 32 and a base of npn transistor 33 are electrically connected to each other. An emitter of npn transistor 32 is electrically connected to both of the base of npn transistor 32 and the base of npn transistor 33. An emitter of npn transistor 33 is electrically connected to a ground potential 35.

Next, a configuration of a semiconductor device with a surge protection circuit in Embodiment 1 will be described.

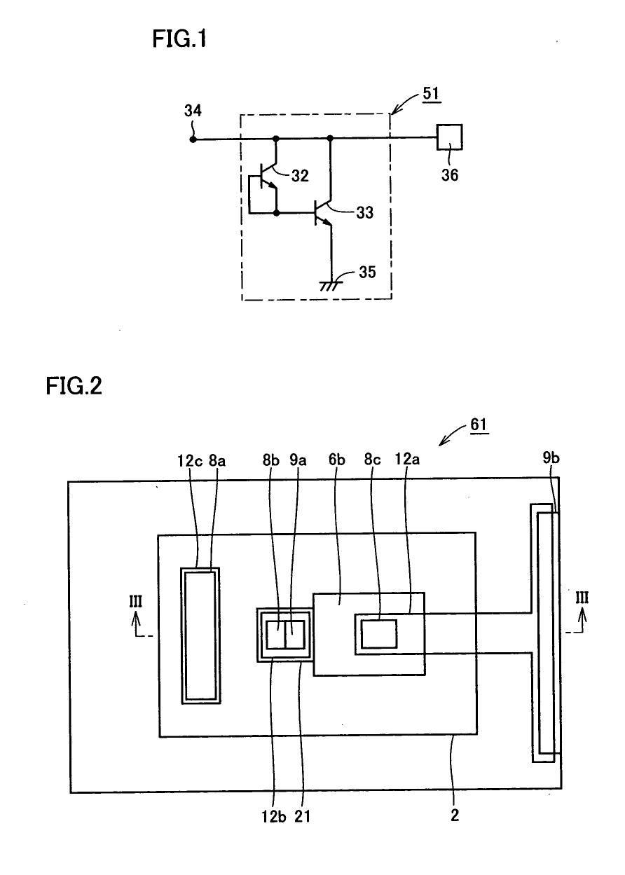

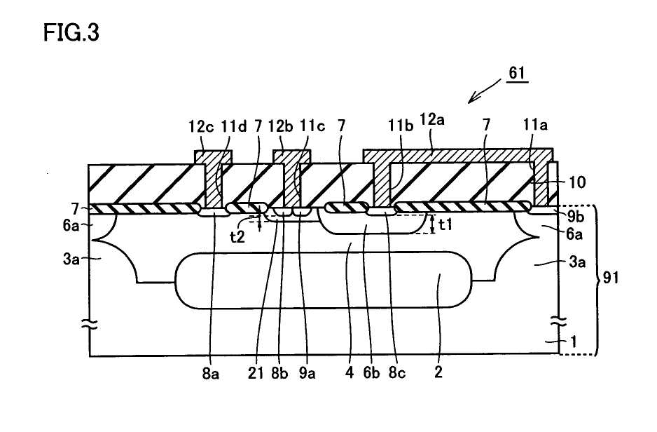

Referring to FIGS. 2 and 3, in a semiconductor device 61, a p⁻ region 1 is formed in a lower portion of a semiconductor substrate 91 composed of monocrystalline silicon, for example. On p⁻ region 1, an n⁺ diffusion layer 2 is formed by injection and diffusion. On n⁺ diffusion layer 2, an n⁻ epitaxial layer 4 is formed. A p⁺ diffusion layer 3a and a p-type diffusion layer 6a are formed on p⁻ region 1, so as to surround n⁻ epitaxial layer 4.

Within n⁺ diffusion layer 2 and n⁻ epitaxial layer 4, npn transistor 32 and npn transistor 33 constituting the surge protection circuit are formed. Each of npn transistor 32 and npn transistor 33 includes an emitter region, a base region, and a collector region.

In npn transistor 32, the collector region is constituted with n⁺ diffusion layer 2, n⁻ epitaxial layer 4, and an n⁺ diffusion layer 8a formed in n⁻ epitaxial layer 4. The base region is constituted with a p⁺ diffusion layer 21 formed in n⁻ epitaxial layer 4, and a p⁺ diffusion layer 9a formed in p+diffusion layer 21. The emitter region is constituted with an n⁺ diffusion layer 8b formed adjacent to p⁺ diffusion layer 9a within p⁺ diffusion layer 21.

In npn transistor 33, the collector region is constituted with n⁻ epitaxial layer 4, n⁺ diffusion layer 2, and an n⁺ diffusion layer 8a, and formed with an impurity region identical to that for the collector of npn transistor 32. The base region is constituted with a p⁻type diffusion layer 6b formed in n⁻ epitaxial layer 4. The emitter region is constituted with an n⁺ diffusion layer 8c formed in p-type diffusion layer 6b.

P⁺ diffusion layer 21 serving as the base region of npn transistor 32 and p-type diffusion layer 6b serving as the base region of npn transistor 33 are formed with impurity diffusion regions different from each other respectively, and are electrically connected to each other. Here, a width t1 represents a width of a narrowest region in p-type diffusion layer 6b serving as the base of npn transistor 33. For example, width t1 represents a width in a depth (depth) of p-type diffusion layer 6b positioned directly under n⁺ diffusion layer 8c. In addition, a width t2 represents a width of a narrowest region in p⁺ diffusion layer 21 serving as the base of npn transistor 32. For example, width t2 represents a width in a depth (depth) of p⁺ diffusion layer 21 positioned directly under n⁺ diffusion layer 8b. Width t2 is smaller than width t1. P⁺ diffusion layer 21 has an impurity density higher than p-type diffusion layer 6b.

Here, p⁺ diffusion layer 21 is a region attaining a function as the base of npn transistor 32, while p-type diffusion layer 6b is a region attaining a function as the base of npn transistor 33.

In addition, p-type diffusion layers 6a, 6b are formed by injecting B (boron) into n⁻ epitaxial layer 4 so as to attain an impurity density of approximately 10¹³/cm³, for example. P⁺ diffusion layer 21 is formed by performing thermal oxidation on the surfaces of n⁻ epitaxial layer 4 and p-type diffusion layer 6b to a depth of several tens of nm, for example, and by injecting B into the surface so as to attain an impurity density of the order of 10¹⁴/cm³, for example. N⁺ diffusion layer 8b is formed by injecting As (arsenic) into the surface of p⁺ diffusion layer 21 so as to attain a density of approximately 10¹⁵/cm³, for example. P⁺ diffusion layer 9a is formed by injecting B or BF₂ into the surface of p⁺ diffusion layer 21 so as to attain a density of approximately 10¹⁵/cm³, for example.

In addition, with a process step identical to the process step in which n⁺ diffusion layer 8b is formed, n⁺ diffusion layers 8a, 8c are formed on the surface of n⁻ epitaxial layer 4 and the surface of p-type diffusion layer 6b respectively. Moreover, with a process step identical to the process step in which p⁺ diffusion layer 9a is formed, a p⁺ diffusion layer 9b is formed on the surface of p-type diffusion layer 6a. N⁺ diffusion layer 8a; p⁺ diffusion layer 21, n⁺ diffusion layer 8b, p⁺ diffusion layer 9a and p-type diffusion layer 6b; n⁺ diffusion layer 8c; and p⁺ diffusion layer 9b are each electrically isolated by field oxide film 7 formed with LOCOS (Local Oxidation of Silicon).

An interlayer insulating film 10 is formed so as to cover the surface of semiconductor substrate 91. In interlayer insulating film 10, contact holes 11a to 11d are each formed. Accordingly, surfaces of n⁺ diffusion layer 8a, n⁺ diffusion layer 8b and p⁺ diffusion layer 9a, n⁺ diffusion layer 8c, and p⁺ diffusion layer 9b are exposed. Interconnections 12a to 12c composed of polycrystalline silicon having an impurity introduced (hereinafter, referred to as “doped polysilicon”), for example, are formed on interlayer insulating film 10, so as to establish electrical connection to each exposed region described above through each contact hole 11a to 11d. Thus, n⁺ diffusion layer 8b is electrically connected to p⁺ diffusion layer 9a, while n⁺ diffusion layer 8c is electrically connected to p⁺ diffusion layer 9b.

Next, an operation of the surge protection circuit according to the present embodiment will be described.

Referring to FIG. 1, when the surge voltage is applied to signal input terminal 34, a voltage between the emitter and the collector of npn transistor 32 rises, and breakdown occurs in npn transistor 32. When breakdown occurs in npn transistor 32, a current flows in the base of npn transistor 33, and npn transistor 33 turns on. When npn transistor 33 turns on, the surge voltage applied to signal input terminal 34 is released to ground potential 35 via npn transistor 33. Thus, application of the surge voltage to device portion 36 is prevented.

Next, a breakdown phenomenon of the transistor will be described. Broadly speaking, the breakdown phenomenon in the transistor includes avalanche breakdown and punchthrough breakdown. Avalanche breakdown refers to a phenomenon in the following. That is, when a large reverse voltage is applied, a pair of an electron and a hole produced in a depletion layer is accelerated in an electric field, and collides with electrons constituting a crystal. Thus, the number of pairs of the electron and the hole exponentially increases, and the current flows. Here, when a density of a p-type region and an n-type region joining with each other is high, the width of the depletion layer is made smaller, and the electric field in the depletion layer will be larger. Therefore, the number of pairs of the electron and the hole tends to increase. Therefore, in the transistor, the higher the density in the region serving as the base is, the more readily avalanche breakdown tends to occur.

Meanwhile, punchthrough breakdown refers to a phenomenon in the following. That is, when a large reverse voltage is applied to the transistor with a low density particularly in the base region, the depletion layer of the base-collector extends to come in contact with the depletion layer of an emitter-base junction. Accordingly, a potential barrier is lowered, an electron or a hole flows directly into the collector from the emitter through the depletion layer, and the current flows.

In the present embodiment, width t2 in the narrowest region of p⁺ diffusion layer 21 serving as the base of npn transistor 32 is smaller than width t1 of p-type diffusion region 6b serving as the base of npn transistor 33. Thus, npn transistor 32 is configured so as to be more susceptible to punchthrough breakdown than npn transistor 33.

In addition, in the present embodiment, p⁺ diffusion layer 21 attaining a function as the base of npn transistor 32 has an impurity density higher than p-type diffusion layer 6b attaining a function as the base of npn transistor 33. Thus, npn transistor 32 is configured so as to be more susceptible to avalanche breakdown than npn transistor 33.

As described above, in the present embodiment, npn transistor 32 is configured such that breakdown (avalanche breakdown or punchthrough breakdown) is ensured to occur earlier than in npn transistor 33. Therefore, malfunction such as breakdown of npn transistor 33 preceding breakdown of npn transistor 32 as in a conventional example can be prevented. In other words, if breakdown is ensured to occur in npn transistor 32 earlier than in npn transistor 33, it is ensured that npn transistor 33 turns on, and that the surge voltage applied to signal input terminal 34 is released. Thus, malfunction can be prevented, and the surge protection circuit attaining a normal operation can be implemented.

In the present embodiment, an example in which the two configurations are both employed has been described. That is, (1) a configuration in which width t2 of p⁺ diffusion layer 21 is smaller than width t1 of p-type diffusion layer 6b; and (2) a configuration in which p⁺ diffusion layer 21 has an impurity density higher than p-type diffusion layer 6b. On the other hand, at least one of the two configurations (1) and (2) should only be included. Specifically, if only the configuration (1) described above is implemented, and npn transistor 32 is configured such that punchthrough breakdown occurs earlier than in npn transistor 33, p⁺ diffusion layer 21 may have an impurity density lower than p-type diffusion layer 6b. Alternatively, if only the configuration (2) described above is implemented, and npn transistor 32 is configured such that avalanche breakdown occurs earlier than in npn transistor 33, width t2 of p⁺ diffusion layer 21 may be smaller than width t1 of p-type diffusion layer 6b. In short, the surge protection circuit should only be configured such that breakdown (avalanche breakdown or punchthrough breakdown) occurs in npn transistor 32 earlier than in npn transistor 33 by adopting at least one of the configurations (1) and (2) described above.

In addition, in the present embodiment, p⁺ diffusion layer 21 serving as the base region of npn transistor 32 and p-type diffusion layer 6b serving as the base region of npn transistor 33 are formed with impurity diffusion regions different from each other respectively, and are electrically connected to each other. Accordingly, the base region of npn transistor 32 can be controlled so as to have a density different from that of the base region of npn transistor 33. Further, width t2 of the base region of npn transistor 32 can be controlled to a width different from width t1 of the base region of npn transistor 33. Therefore, depending on the configuration of the base region of npn transistor 32, the withstand voltage of npn transistor 32 can readily be set to be lower than that of npn transistor 33. Thus, the surge protection circuit attaining a normal operation can readily be implemented.

(Embodiment 2)

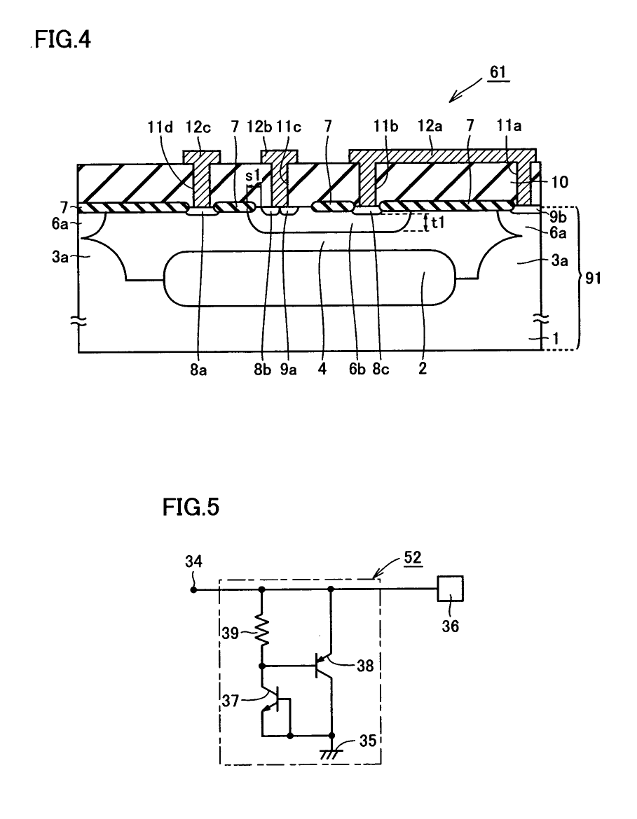

Referring to FIG. 4, a semiconductor device in the present embodiment has a configuration different from that in Embodiment 1 in that the base region of npn transistor 32 and the base region of npn transistor 33 share identical p-type diffusion layer 6b. Therefore, n⁺ diffusion layer 8c, p⁺ diffusion layer 9a and n⁺ diffusion layer 8b are formed within p-type diffusion layer 6b.

The base region of npn transistor 32 is constituted with p-type diffusion layer 6b and p⁺ diffusion layer 9a. The base region of npn transistor 33 is constituted with p-type diffusion layer 6b. In this configuration, the narrowest region of the base region of npn transistor 32 is a region of p-type diffusion layer 6b to the side of n⁺ diffusion layer 8b in the figure, which has a width s1. The narrowest region of the base region of npn transistor 33 is a region of p-type diffusion layer 6b located directly under n⁺ diffusion layer 8c in the figure, which has a width t1. Width s1 is smaller than t1. In addition, p-type diffusion layer 6b is a region attaining a function as the base of npn transistor 32 as well as a function as the base of npn transistor 33.

Here, since a configuration is otherwise approximately similar to that in Embodiment 1 shown in FIGS. 1 to 3, the same reference characters refer to the same components, and description therefor will not be provided.

In the present embodiment, p-type diffusion layer 6b serving as the base region of npn transistor 32 and p-type diffusion layer 6b serving as the base region of npn transistor 33 are formed with an identical impurity diffusion region. With such a configuration, if width s1 of the base region of npn transistor 32 is made smaller than width t1 of the base region of npn transistor 33, npn transistor 32 is more susceptible to punchthrough breakdown than npn transistor 33. Therefore, the surge protection circuit attaining a normal operation can be formed, and the number of impurity diffusion regions is reduced. Thus, a manufacturing process of a semiconductor device is simplified.

(Embodiment 3)

Referring to FIG. 5, a surge protection circuit 52 includes an npn transistor 37, a pnp transistor 38, and a resistance element 39. An emitter of pnp transistor 38 and one end of resistance element 39 are each electrically connected to signal input terminal 34 and device portion 36. A base of npn transistor 37 and a collector of pnp transistor 38 are electrically connected to each other, and each electrically connected to ground potential 35. An emitter of npn transistor 37 is electrically connected to the base of npn transistor 37, the collector of pnp transistor 38, and ground potential 35. A collector of npn transistor 37 is electrically connected to a base of pnp transistor 38 and another end of resistance element 39.

Next, a configuration of a semiconductor device with a surge protection circuit in Embodiment 3 will be described.

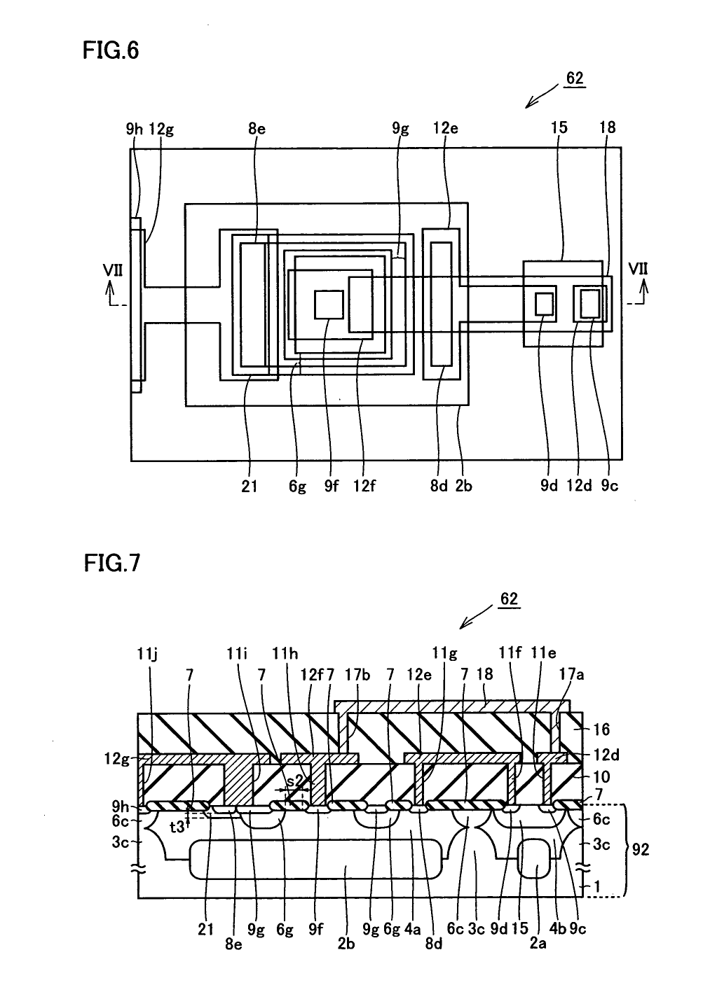

Referring to FIGS. 6 and 7, in a semiconductor device 62, p⁻ region 1 is formed in a lower portion of a semiconductor substrate 92 composed of monocrystalline silicon, for example. On p⁻ region 1, n⁺ diffusion layers 2a, 2b are formed by injection and diffusion. On each of n⁺ diffusion layers 2a, 2b, n⁻ epitaxial layers 4a, 4b are each formed. A p⁺ diffusion layer 3c and a p-type diffusion layer 6c are formed so as to surround n⁻ epitaxial layers 4a, 4b. Thus, n⁻ epitaxial layer 4a is electrically isolated from n⁻ epitaxial layer 4b, and N⁺ diffusion layer 2a is electrically isolated from n⁺ diffusion layer 2b.

In n⁺ diffusion layer 2b and n-epitaxial layer 4a, npn transistor 37 and pnp transistor 38 constituting the surge protection circuit are formed. Npn transistor 37 and pnp transistor 38 each include the emitter region, the base region, and the collector region.

In npn transistor 37, the collector region is constituted with n⁺ diffusion layer 2b, n-epitaxial layer 4a, and an n⁺ diffusion layer 8d formed in n⁻ epitaxial layer 4a. The base region is constituted with p⁺ diffusion layer 21 formed in n⁻ epitaxial layer 4a, a p-type diffusion layer 6g formed adjacent to p⁺ diffusion layer 21 within n⁻ epitaxial layer 4a, and a p⁺ diffusion layer 9g formed within p-type diffusion layer 6g. The emitter region is constituted with an n⁺ diffusion layer 8e formed adjacent to p⁺ diffusion 9g within p⁺ diffusion layer 21.

In pnp transistor 38, the emitter region is constituted with a p⁺diffusion layer 9f formed in n⁻ epitaxial layer 4a. The base region is formed with n⁻ epitaxial layer 4a and n⁺ diffusion layer 2b. The collector region is formed with p-type diffusion layer 6 and p⁺ diffusion layer 9g.

Here, p-type diffusion layer 6g and p⁺ diffusion layer 9g are formed on the surface of semiconductor substrate 92 so as to surround a side of p⁺ diffusion layer 9f in the figure.

In n⁻ epitaxial layer 4b, resistance element 39 constituting the surge protection circuit is formed. Resistance element 39 is constituted with a p⁺ diffusion layer 15 formed in n⁻ epitaxial layer 4b, and p⁺ diffusion layers 9c, 9d formed in p⁺ diffusion layer 15.

In this configuration, a narrowest region in the base region of npn transistor 37 is a region in p⁺ diffusion layer 21 located directly under n⁺ diffusion layer 8e in the figure, which has a width t3. A narrowest region in the base region of pnp transistor 38 is a region m n epitaxial layer 4a to the side of p⁺ diffusion layer 9f in the figure, which has a width s2. Width t3 is smaller than width s2. In addition, p⁺ diffusion layer 21 is a region attaining a function as the base of npn transistor 37, while n⁻ epitaxial layer 4a is a region attaining a function as the base of pnp transistor 38. P⁺ diffusion layer 21 serving as a region attaining a function as the base of npn transistor 37 is formed with a region of one conductivity type, and n⁻ epitaxial layer 4a serving as a region attaining a function as the base of pnp transistor 38 is formed with a region of an opposite conductivity type.

P⁺ diffusion layer 15 is formed by performing thermal oxidation on the surfaces of n⁻ epitaxial layer 4b to a depth of several tens of nm, for example, and by injecting B into the surface so as to attain an impurity density of the order of 10¹⁴/cm³. In addition, with a process step identical to the process step in which n⁺ diffusion layer 8e is formed, n⁺ diffusion layer 8d is formed on the surface of n⁻ epitaxial layer 4a. Further, with a process step identical to the process step in which p⁺ diffusion layer 9g is formed, p+diffusion layers 9c, 9d are formed on the surface of p⁺ diffusion layer 15; p⁺ diffusion layer 9f is formed on the surface of n⁻ epitaxial layer 4a; and a p⁺ diffusion layer 9h is formed on the surface of p-type diffusion layer 6c. P⁺ diffusion layer 15 and p⁺ diffusion layers 9c, 9d; n⁺ diffusion layer 8d; p⁺ diffusion layer 9g; p⁺ diffusion layer 9f; p⁺ diffusion layer 9g, n⁺ diffusion layer 8e and p⁺ diffusion layer 21; and p⁺ diffusion layer 9h are each electrically isolated by field oxide film 7.

Interlayer insulating film 10 is formed so as to cover the surface of semiconductor substrate 92. In interlayer insulating film 10, contact holes 11e to 11j are each formed. Accordingly, surfaces of p⁺ diffusion layer 9c, p⁺ diffusion layer 9d, n⁺ diffusion layer 8d, p⁺ diffusion layer 9f, p⁺ diffusion layer 9g and n⁺ diffusion layer 8e, and p⁺ diffusion layer 9h are exposed. Interconnections 12d to 12g composed of doped polysilicon, for example, are formed on interlayer insulating film 10, so as to establish electrical connection to each exposed region described above through each of contact holes 11e to 11j. Thus, p⁺ diffusion layer 9d is electrically connected to n⁺ diffusion layer 8d, while p⁺ diffusion layer 9g, n⁺ diffusion layer 8e, and p⁺ diffusion layer 9h are each electrically connected. An interlayer insulating film 16 is formed so as to cover interconnections 12d to 12g. In interlayer insulating film 16, contact holes 17a, 17b are each formed. An interconnection 18 composed of doped polysilicon, for example, is formed in contact holes 17a, 17b. Thus, interconnection 12d is electrically connected to interconnection 12f.

Next, an operation of the surge protection circuit in the present embodiment will be described.

Referring to FIG. 5, when the surge voltage is applied to signal input terminal 34, the voltage between the emitter and the collector of npn transistor 37 rises, and breakdown occurs in npn transistor 37. When breakdown occurs in npn transistor 37, a potential difference is produced between opposite ends of resistance element 39, and the current flows in resistance element 39. In addition, a potential of the base of pnp transistor 38 attains the ground potential. Accordingly, pnp transistor 38 turns on, and the surge voltage input to signal input terminal 34 is released to ground potential 35 via pnp transistor 38. Thus, application of the surge voltage to device portion 36 is prevented.

In the present embodiment, p⁺ diffusion layer 21 serving as the base region of npn transistor 37 is formed with a region of one conductivity type, and n⁻ epitaxial layer 4a serving as the base region of pnp transistor 38 is formed with a region of an opposite conductivity type. Therefore, if width t3 of the base of npn transistor 37 is made smaller than width s2 of the base of pnp transistor 38, npn transistor 37 is configured so as to be more susceptible to punchthrough breakdown than pnp transistor 38. In addition, if p⁺ diffusion layer 21 attaining a function as the base of npn transistor 37 has an impurity density higher than the n⁻ epitaxial layer attaining a function as the base of pnp transistor 38, npn transistor 37 is configured so as to be more susceptible to avalanche breakdown than pnp transistor 38.

Therefore, if npn transistor 37 is configured so as to be more susceptible to breakdown (avalanche breakdown or punchthrough breakdown) than pnp transistor 38, the surge protection circuit attains a normal operation.

In the present embodiment, an example in which two configurations are both included has been described. That is, (1) a configuration in which width t3 of p⁺ diffusion layer 21 is smaller than width s2 of n⁻ epitaxial layer 4a; and (2) a configuration in which p⁺ diffusion layer 21 has an impurity density higher than n⁻ epitaxial layer 4a. On the other hand, at least one of the two configurations (1) and (2) described above should only be included.

(Embodiment 4)

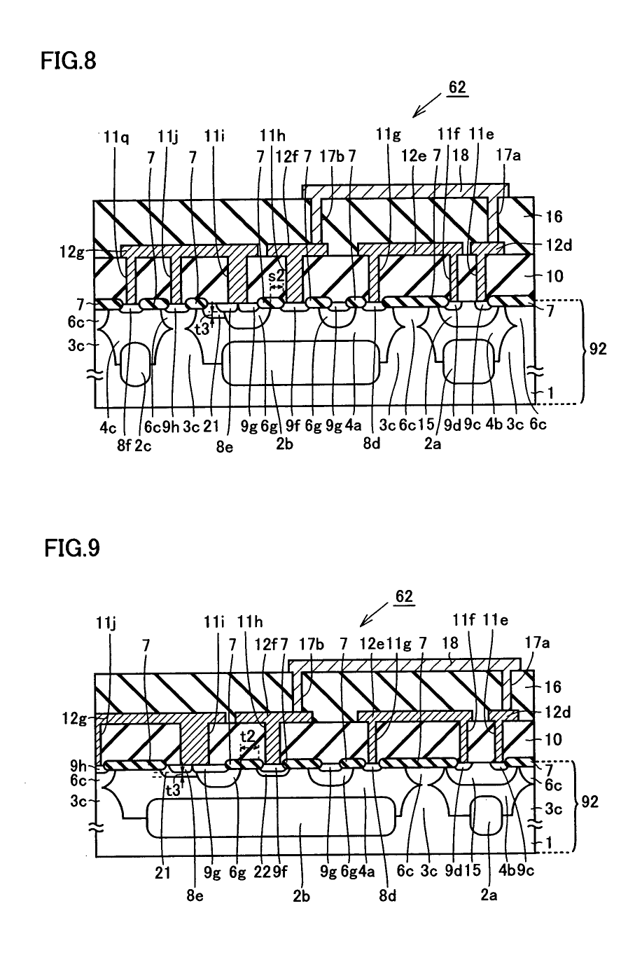

Referring to FIG. 8, in a semiconductor device in the present embodiment, an n⁺ diffusion layer 2c and an n⁻ epitaxial layer 4c electrically isolated from n⁺ diffusion layer 2b and n⁻ epitaxial layer 4a by p⁺ diffusion layer 3c and p-type diffusion layer 6c are formed. On the surface of n⁻ epitaxial layer 4c, an n⁺ diffusion layer 8f is formed. A contact hole 11q is formed so as to expose the surface of n⁺ diffusion layer 8f. Interconnection 12g is formed in contact hole 11q. Therefore, n⁺ diffusion layer 8f, p⁺ diffusion layer 9h, and n⁺ diffusion layer 8e and p⁺ diffusion layer 9g are electrically connected.

Here, since a configuration is otherwise approximately similar to that in Embodiment 3 shown in FIGS. 5 to 7, the same reference characters refer to the same components, and description therefor will not be provided.

In the present embodiment, the emitter and the base of npn transistor 37 and the collector of pnp transistor 38 are electrically connected to n⁻ epitaxial layer 4c electrically isolated from n⁻ epitaxial layer 4a where npn transistor 37 and pnp transistor 38 are formed. Accordingly, when electrons are injected from the lower portion of semiconductor substrate 92, electrons are absorbed in a region of n⁻ epitaxial layer 4c, and introduction of electrons into a circuit is prevented. Therefore, malfunction of the surge protection circuit can be avoided.

(Embodiment 5)

Referring to FIG. 9, in a semiconductor device in the present embodiment, the emitter region of pnp transistor 38 is constituted with a p⁺ diffusion layer 22 formed on the surface of n⁻ epitaxial layer 4a, and p⁺ diffusion layer 9f formed in p⁺ diffusion layer 22. Accordingly, p⁺ diffusion layer 22 surrounds p⁺ diffusion layer 9f, and constitutes a pn junction with n⁻ epitaxial layer 4a serving as the base region of pnp transistor 38. It is to be noted that p⁺ diffusion layer 22 is formed in a process step identical to the process step in which p⁺ diffusion layer 21 is formed.

Here, since a configuration is otherwise approximately similar to that in Embodiment 3 shown in FIGS. 5 to 7, the same reference characters refer to the same components, and description therefor will not be provided.

In the present embodiment, p⁺ diffusion layer 22 is formed so as to surround p⁺ diffusion layer 9f. Therefore, since a pn junction area of pnp transistor 38 increases, a larger amount of current can flow. Thus, the surge protection circuit can be adapted to a larger surge current.

(Embodiment 6)

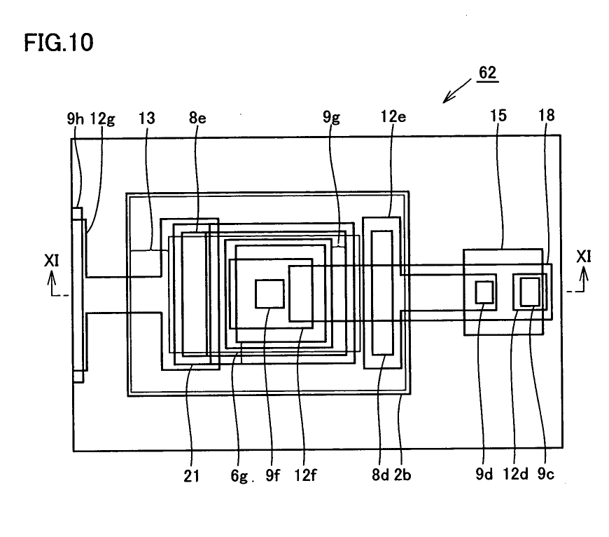

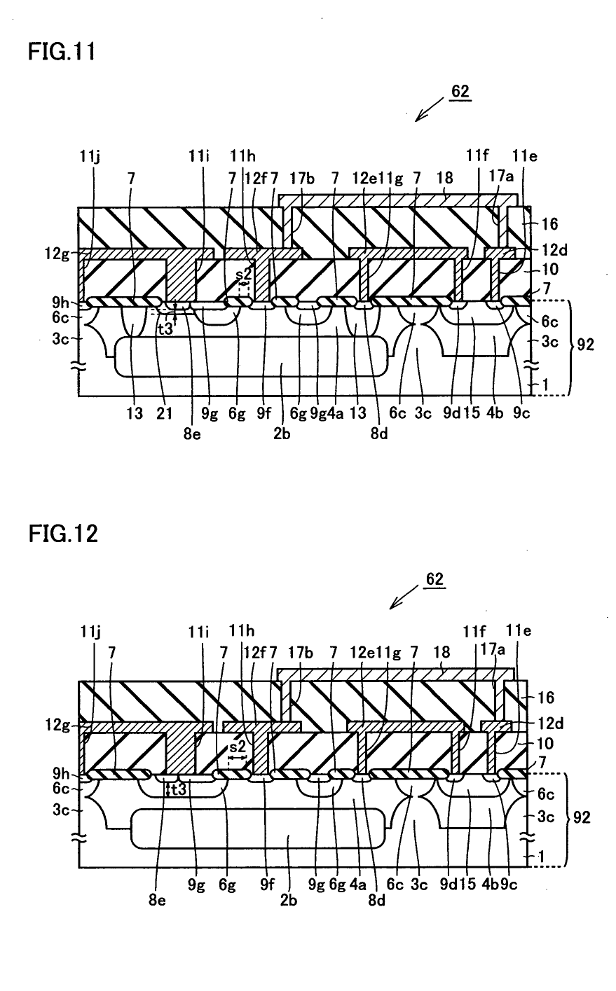

Referring to FIGS. 10 and 11, in a semiconductor device in the present embodiment, an n⁺ diffusion layer 13 is formed so as to surround a side portion of the region where npn transistor 37 and pnp transistor 38 are formed within n⁻ epitaxial layer 4a in the figure, and so as to come in contact with n⁺ diffusion layer 2b on the whole circumference. Thus, the side portion and the lower portion of the region where npn transistor 37 and pnp transistor 38 are formed in n⁻ epitaxial layer 4a in the figure are surrounded by n⁺ diffusion layer 13 and n⁺ diffusion layer 2b. N⁺ diffusion layer 13 and n⁺ diffusion layer 2b have an impurity density higher than n⁻ epitaxial layer 4a.

Here, since a configuration is otherwise approximately similar to that in Embodiment 3 shown in FIGS. 5 to 7, the same reference characters refer to the same components, and description therefor will not be provided.

In the present embodiment, the side portion and the lower portion of the region where npn transistor 37 and pnp transistor 38 are formed in n⁻ epitaxial layer 4a in the figure are surrounded by n⁺ diffusion layer 13 and n⁺ diffusion layer 2b that have an impurity density higher than n epitaxial layer 4a. Thus, when the surge voltage is applied to the collector region of npn transistor 37 and the base region of pnp transistor 38, the surge current tends to flow from n⁻ epitaxial layer 4a to n⁺ diffusion layer 13 and n⁺ diffusion layer 2b. Therefore, the flow of the surge current from n⁻ epitaxial layer 4a into p⁻ region 1, p⁺ diffusion layer 3c and p-type diffusion layer 6c is suppressed. Accordingly, leakage of the surge current is prevented, and malfunction of the surge protection circuit is avoided.

(Embodiment 7)

Referring to FIG. 12, a semiconductor device in the present embodiment is different from that in Embodiment 3 in that the base region of npn transistor 37 and the collector region of pnp transistor 38 share the identical p-type diffusion layer 6g. Therefore, p⁺ diffusion layer 9g and n⁺ diffusion layer 8e are formed in p-type diffusion layer 6g.

The base region of npn transistor 37 is constituted with p-type diffusion layer 6g and p⁺ diffusion layer 9g. In this configuration, the narrowest region of the base region of npn transistor 37 is a region of p-type diffusion layer 6g located directly under n⁺ diffusion layer 8e in the figure, which has width t3. Width t3 is smaller than width s2. In addition, p-type diffusion layer 6g is a region attaining a function as the base of npn transistor 37.

Here, since a configuration is otherwise approximately similar to that in Embodiment 3 shown in FIGS. 5 to 7, the same reference characters refer to the same components, and description therefor will not be provided.

In the present embodiment, p-type diffusion layer 6g serving as the base region of npn transistor 37 and p-type diffusion layer 6g serving as the collector region of pnp transistor 38 are formed with the identical impurity diffusion region. With such a configuration, when width t3 of the base region of npn transistor 37 is made smaller than width s2 of the base region of pnp transistor 38, npn transistor 37 is configured so as to be more susceptible to punchthrough breakdown than pnp transistor 38. Therefore, the surge protection circuit attaining a normal operation can be formed, and the number of the impurity diffusion regions can be reduced by one. Thus, the manufacturing process of a semiconductor device is simplified.

(Embodiment 8)

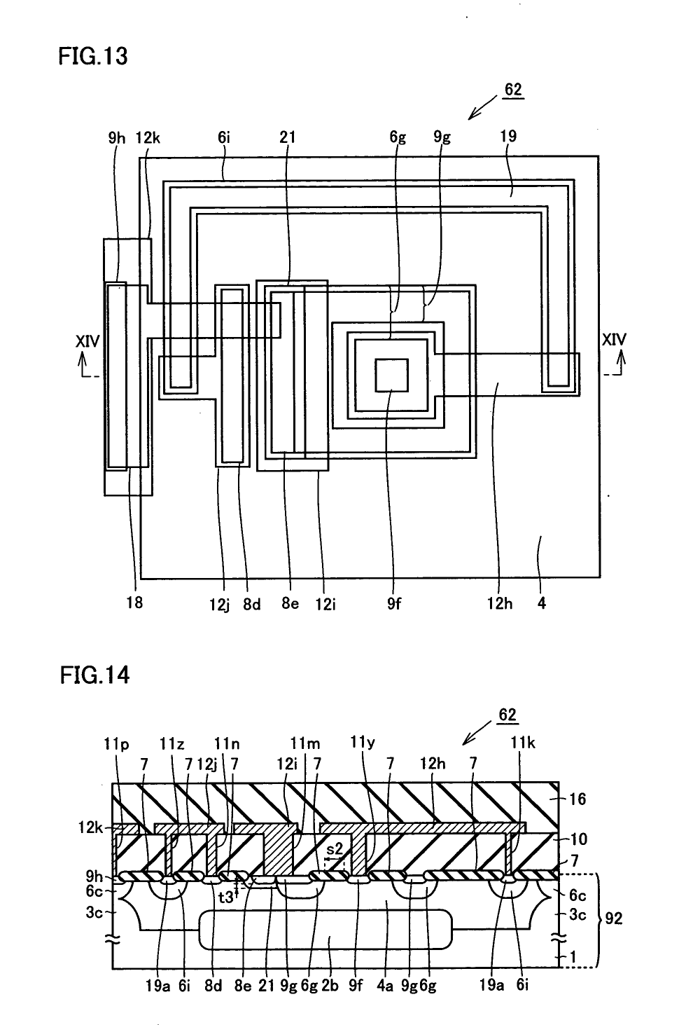

Referring to FIGS. 13 and 14, in semiconductor device 62 in the present embodiment, a configuration of resistance element 39 is different from that in Embodiment 3 shown in FIGS. 5 to 7.

Resistance element 39 is constituted with an n⁺ diffusion layer 19a, and formed in n epitaxial layer 4a where npn transistor 37 and pnp transistor 38 are formed. A p-type diffusion layer 6i for electrically isolating n⁺ diffusion layer 19a serving as resistance element 39 is also formed in n⁻ epitaxial layer 4a. Accordingly, n⁺ diffusion layer 19a is surrounded by p-type diffusion layer 6i.

As shown in FIG. 13, n⁺ diffusion layer 19a and p-type diffusion layer 6i extend on the surface of semiconductor substrate 92, so as to extend from one side of a forming region of npn transistor 37 and pnp transistor 38 toward the other side thereof, bypassing the forming region, when viewed two-dimensionally. In addition, n⁺ diffusion layer 8d formed on the right side of the forming region of npn transistor 37 and pnp transistor 38 in FIG. 7 is formed on the left side thereof in the present embodiment.

Here, n⁺ diffusion layer 19a is formed by injecting As (arsenic) into the surface of p-type diffusion layer 6i so as to attain a density of approximately 10¹⁴˜10¹¹/cm³, for example. N⁺ diffusion layer 19a; p⁺ diffusion layer 9g; p⁺ diffusion layer 9f; p⁺ diffusion layer 9g, n⁺ diffusion layer 8e and p⁺ diffusion layer 21; n⁺ diffusion layer 8d; and p⁺ diffusion layer 9h are each electrically isolated by field oxide film 7.

Here, since a configuration in semiconductor substrate 92 in the present embodiment is approximately similar to that in semiconductor substrate 92 in Embodiment 3 shown in FIGS. 5 to 7, the same reference characters refer to the same components, and description therefor will not be provided.

Interlayer insulating film 10 is formed so as to cover the surface of semiconductor substrate 92. In interlayer insulating film 10, contact holes 11k, 11m, 11n, 11p, 11y, 11z are each formed. Accordingly, surfaces of n⁺ diffusion layer 19a, p⁺ diffusion layer 9f, p⁺ diffusion layer 9g and n⁺ diffusion layer 8e, n⁺ diffusion layer 8d, and p⁺ diffusion layer 9h are exposed. Interconnections 12h to 12k composed of doped polysilicon, for example, are formed in contact holes 11k, 11m, 11n, 11p, 11y, 11z. Thus, n⁺ diffusion layer 19a is electrically connected to p⁺ diffusion layer 9f; p⁺ diffusion layer 9g is electrically connected to n⁺ diffusion layer 8e; and n⁺ diffusion layer 8d is electrically connected to n⁺ diffusion layer 19a. Interlayer insulating film 16 is formed so as to cover interconnections 12h to 12k. In interlayer insulating film 16, contact holes (not shown) are each formed so as to expose the surfaces of interconnections 12i and 12k. Interconnection 18 (FIG. 13) composed of doped polysilicon, for example, is formed in the contact hole. Thus, interconnection 12i is electrically connected to interconnection 12k.

In the present embodiment, n⁺ diffusion layer 19a constituting resistance element 39 is formed in n⁻ epitaxial layer 4 where npn transistor 37 and pnp transistor 38 are formed. Moreover, n⁺ diffusion layer 19a is each surrounded by p-type diffusion layer 6i. Therefore, leakage into n⁻ epitaxial layer 4 of the current flowing in n⁺ diffusion layer 19a constituting resistance element 39 is suppressed by p-type diffusion layer 6i. Accordingly, it is not necessary to form resistance element 39 electrically isolated from npn transistor 37 and pnp transistor 38, which will achieve smaller element area.

(Embodiment 9)

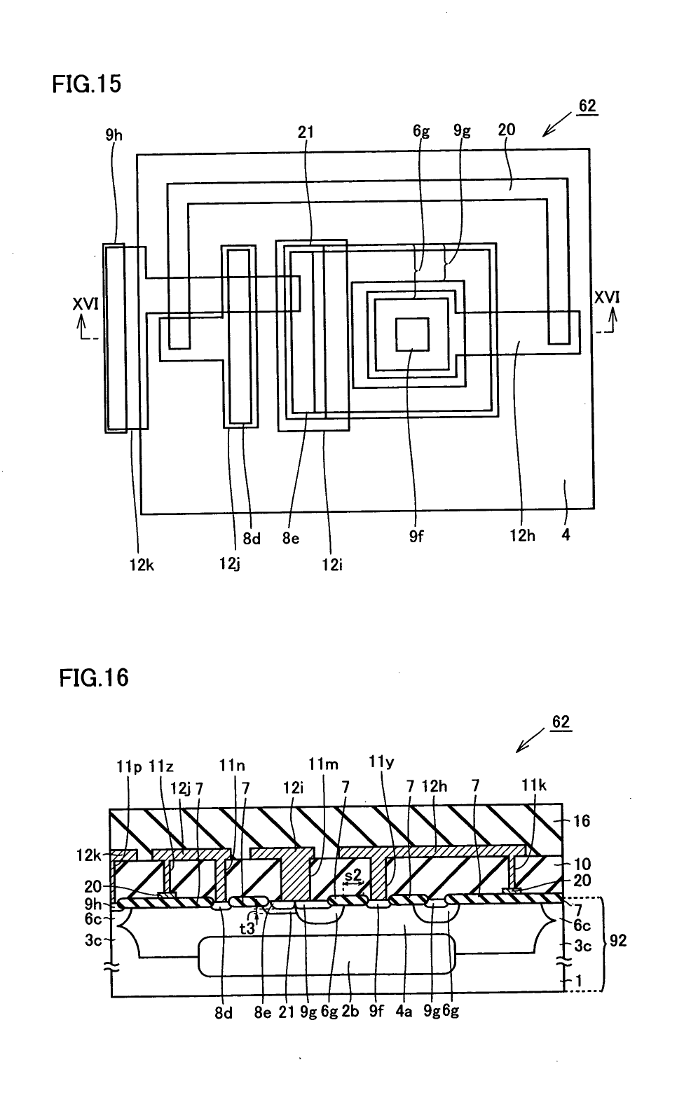

Referring to FIGS. 15 and 16, in a semiconductor device in the present embodiment, resistance element 39 is formed with a conductive layer 20. Conductive layer 20 is formed above the surface of semiconductor substrate 92, for example, on field oxide film 7. Conductive layer 20 is composed of doped polysilicon, for example. In the present embodiment, p-type diffusion layer 6i and n⁺ diffusion layer 19a are not formed.

Here, since a configuration is otherwise approximately similar to that in Embodiment 8 shown in FIGS. 13 and 14, the same reference characters refer to the same components, and description therefor will not be provided.

In the present embodiment, resistance element 39 is completely, electrically isolated from npn transistor 37 and pnp transistor 38. Therefore, when the surge voltage is applied to resistance element 39, the region where npn transistor 37 and pnp transistor 38 are formed will not be affected. Accordingly, smaller element area is achieved, and malfunction of the surge protection circuit is completely prevented.

(Embodiment 10)

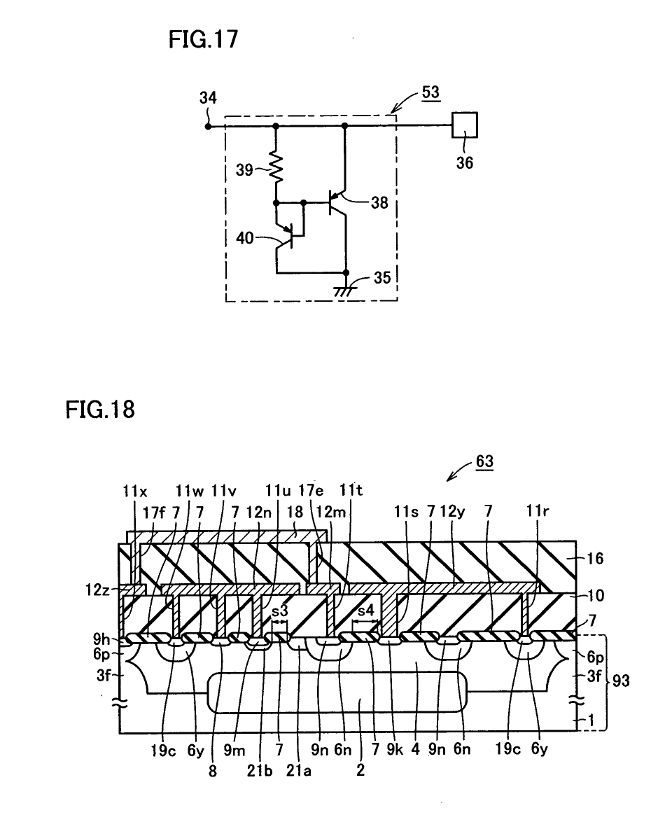

Referring to FIG. 17, a surge protection circuit 53 includes a pnp transistor 40, pnp transistor 38 and resistance element 39. The emitter of pnp transistor 38 and one end of resistance element 39 are electrically connected to signal input terminal 34 and device portion 36. A base of pnp transistor 40 and the base of pnp transistor 38 are electrically connected to each other. An emitter of pnp transistor 40 is electrically connected to the base of pnp transistor 40 and the base of pnp transistor 38. Another end of resistance element 39 is electrically connected to the emitter of pnp transistor 40, the base of pnp transistor 40, and the base of pnp transistor 38. A collector of pnp transistor 40 is electrically connected to the collector of pnp transistor 38 and ground potential 35.

Next, a configuration of a semiconductor device with a surge protection circuit in Embodiment 10 will be described.

Referring to FIG. 18, in a semiconductor device 63, p⁻ region 1 is formed in the lower portion of a semiconductor substrate 93 composed of monocrystalline silicon, for example. On p⁻ region 1, n⁺ diffusion layer 2 is formed by injection and diffusion. N⁻ epitaxial layer 4 is formed on n⁺ diffusion layer 2. A p⁺ diffusion layer 3f and a p-type diffusion layer 6p are formed on p⁻ region 1 so as to surround n⁻ epitaxial layer 4.

In n⁺ diffusion layer 2 and n⁻ epitaxial layer 4, pnp transistor 40 and pnp transistor 38 constituting the surge protection circuit are formed. Each of pnp transistor 40 and pnp transistor 38 includes the emitter region, the base region, and the collector region.

In pnp transistor 40, the emitter region is constituted with a p⁺ diffusion layer 21b formed in n⁻ epitaxial layer 4, and a p⁺ diffusion layer 9m formed in p⁺ diffusion layer 21b. The base region is constituted with n epitaxial layer 4, an n⁺ diffusion layer 8 formed in n⁻ epitaxial layer 4, and n⁺ diffusion layer 2. The collector region is constituted with a p⁺ diffusion layer 21a formed in n⁻ epitaxial layer 4, a p-type diffusion layer 6n formed adjacent to p⁺ diffusion layer 21a in n⁻ epitaxial layer 4, and a p⁺ layer 9n formed in p-type diffusion layer 6n.

In pnp transistor 38, the emitter region is constituted with a p⁺ diffusion layer 9k formed in n epitaxial layer 4. The base region is constituted with n⁻ epitaxial layer 4 and n⁺ diffusion layer 2. The collector region is constituted with p-type diffusion layer 6n and p⁺ diffusion layer 9n.

Though not shown, p-type diffusion layer 6n and p⁺ diffusion layer 9n are formed on the surface of semiconductor substrate 93, so as to surround a side portion of p⁺ diffusion layer 9k in the figure.

In n⁻ epitaxial layer 4, a p-type diffusion layer 6y for isolating the resistance element is formed. Resistance element 39 is constituted with an n⁺ diffusion layer 19c formed in p-type diffusion layer 6y. Though not shown, an n⁺ diffusion layer 19c and p-type diffusion layer 6y extend on the surface of semiconductor substrate 93, so as to extend from one side of a forming region of pnp transistor 40 and pnp transistor 38 toward the other side thereof, bypassing the forming region, when viewed two-dimensionally.

In this configuration, a narrowest region of the base region of pnp transistor 40 is a region of n epitaxial layer 4 to the side of p⁺ diffusion layer 21a in the figure, which has a width s3. The narrowest region of the base region of pnp transistor 38 is a region of n⁻ epitaxial layer 4 to the side of p+diffusion layer 9k in the figure, which has a width s4. Width s3 is smaller than width s4. In addition, n⁻ epitaxial layer 4 is a region attaining a function as the base of pnp transistor 40, while n⁻ epitaxial layer 4 is a region attaining a function as the base of a pnp transistor 41. N⁻ epitaxial layer 4 serving as the region attaining a function as the base of pnp transistor 40 and n⁻ epitaxial layer 4 serving as the region attaining a function as the base of pnp transistor 38 are formed with the identical impurity diffusion region.

With a process step identical to the process step in which p⁺ diffusion layer 9n is formed, p⁺ diffusion layer 9k is formed on the surface of n⁻ epitaxial layer 4; p⁺ diffusion layer 9m is formed on the surface of p⁺ diffusion layer 21b; and p⁺ diffusion layer 9h is formed on the surface of p-type diffusion layer 6p. N⁺ diffusion layer 19c; p⁺ diffusion layer 9n; p⁺ diffusion layer 9k; p⁺ diffusion layer 9n, p-type diffusion layer 6n and p⁺ diffusion layer 21a; p⁺ diffusion layer 9m; n⁺ diffusion layer 8; n⁺ diffusion layer 19c; and p⁺ diffusion layer 9h are each electrically isolated by field oxide film 7 formed on the main surface of semiconductor substrate 93. Thus, p⁺ diffusion layer 21a serving as the emitter region of pnp transistor 40, and p⁺ diffusion layer 21b serving as the collector region of pnp transistor 40 are formed on the main surface of semiconductor substrate 93, so as to interpose field oxide film 7 therebetween.

Interlayer insulating film 10 is formed so as to cover the surface of semiconductor substrate 93. In interlayer insulating film 10, contact holes 11r to 11x are each formed. Accordingly, surfaces of n⁺ diffusion layer 19c, p+diffusion layer 9k, p⁺ diffusion layer 9n, p⁺ diffusion layer 9m, n⁺ diffusion layer 8, and p⁺ diffusion layer 9h are exposed. Interconnections 12m, 12n, 12y, 12z composed of doped polysilicon, for example, are formed on interlayer insulating film 10, so as to establish electrical connection with each exposed region described above through each of contact holes 11r to 11x. Thus, n⁺ diffusion layer 19c is electrically connected to p⁺ diffusion layer 9k; and p⁺ diffusion layer 9m, n⁺ diffusion layer 8, and n⁺ diffusion layer 19c are each electrically connected. Interlayer insulating film 16 is formed so as to cover interconnections 12m, 12n, 12y, 12z. In interlayer insulating film 16, contact holes 17e, 17f are each formed. Interconnection 18 composed of doped polysilicon, for example, is formed in contact holes 17e, 17f. Thus, interconnection 12m is electrically connected to interconnection 12z.

Next, an operation of the surge protection circuit in the present embodiment will be described.

Referring to FIG. 17, when the surge voltage is applied to signal input terminal 34, the voltage between the emitter and the collector of pnp transistor 40 rises, and breakdown occurs in pnp transistor 40. When breakdown occurs in pnp transistor 40, a potential difference is produced between opposite ends of resistance element 39, and the current flows in resistance element 39. In addition, a potential of the base of pnp transistor 38 attains the ground potential. Accordingly, pnp transistor 38 turns on, and the surge voltage input to signal input terminal 34 is released to ground potential 35 via pnp transistor 38. Thus, application of the surge voltage to device portion 36 is prevented.

In the present embodiment, semiconductor 63 includes a circuit in FIG. 17. Therefore, by breakdown of pnp transistor 40, pnp transistor 38 turns on, and the surge voltage applied to signal input terminal 34 can be released to ground potential 35. Accordingly, by implementing such a configuration that pnp transistor 40 is more susceptible to breakdown than pnp transistor 38, the surge protection circuit can achieve a normal operation.

In the present embodiment, width s3 of the base region of pnp transistor 40 can freely be controlled by field oxide film 7. Therefore, by making width s3 smaller than width s4, a configuration in which pnp transistor 40 is more susceptible to punchthrough breakdown than pnp transistor 38 can readily be implemented.

(Embodiment 11)

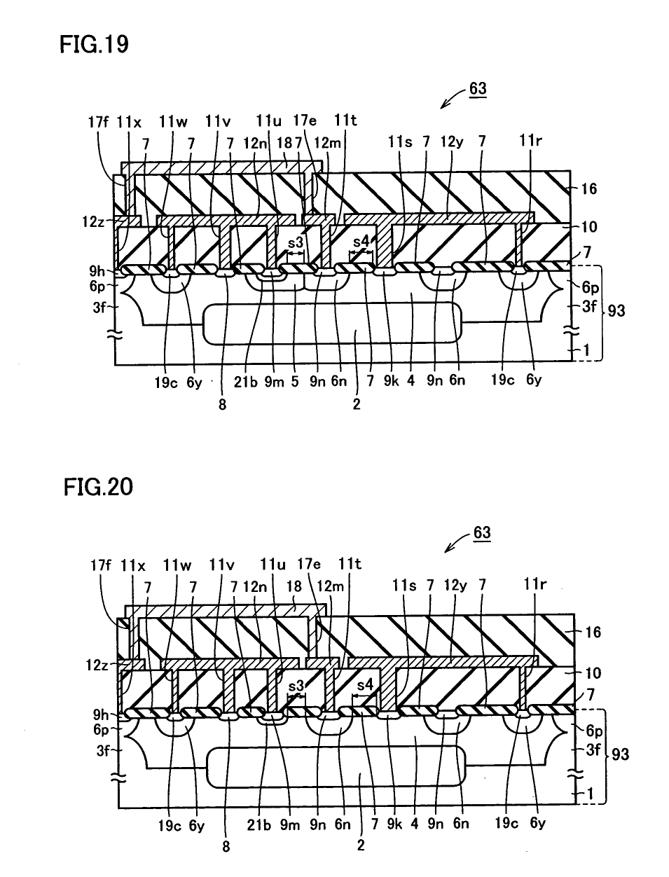

Referring to FIG. 19, in a semiconductor device in the present embodiment, an n-type diffusion layer 5 is formed in n⁻ epitaxial layer 4 formed on the main surface of semiconductor substrate 93. N-type diffusion layer 5 has an impurity density higher than n⁻ epitaxial layer 4. N-type diffusion layer 5 is formed so as to surround p⁺ diffusion layer 21b. N-type diffusion layer 5 and p-type diffusion layer 6n are arranged adjacent to each other on the main surface within n⁻ epitaxial layer 4. P⁺ diffusion layer 21a is not formed.

In pnp transistor 40, the base region is constituted with n-type diffusion layer 5 formed in n⁻ epitaxial layer 4. The collector region is formed with p-type diffusion layer 6n formed in n⁻ epitaxial layer 4, and p⁺ diffusion layer 9n formed in p-type diffusion layer 6n. In this configuration, the narrowest region of the base region of pnp transistor 40 is a region of n-type diffusion layer 5 to the side of p-type diffusion layer 6n in the figure, which has width s3. Width s3 is smaller than width s4. In addition, n-type diffusion layer 5 serves as a region attaining a function as the base of pnp transistor 40. N-type diffusion layer 5 is formed by injecting B into the surface of n⁻ epitaxial layer 4 so as to attain an impurity density of the order of 10¹²/cm³, for example.

Here, since a configuration is otherwise approximately similar to that in Embodiment 17 shown in FIG. 10, the same reference characters refer to the same components, and description therefor will not be provided.

In the present embodiment, width s3 of the base region of pnp transistor 40 can freely be controlled by field oxide film 7. Therefore, by making width s3 smaller than width s4, a configuration in which pnp transistor 40 is more susceptible to punchthrough breakdown than pnp transistor 38 can readily be implemented.

In addition, in the present embodiment, n-type diffusion layer 5 attaining a function as the base of pnp transistor 40 has an impurity density higher than n⁻ epitaxial layer 4 attaining a function as the base of pnp transistor 38. Thus, pnp transistor 40 is configured so as to be more susceptible to avalanche breakdown than pnp transistor 38.

(Embodiment 12)

Referring to FIG. 20, in a semiconductor device in the present embodiment, p⁺ diffusion layer 21a is not formed. Therefore, in pnp transistor 40, the collector region is formed with p-type diffusion layer 6n formed in n⁻ epitaxial layer 4 and with p⁺ diffusion layer 9n formed in p-type diffusion layer 6n. In addition, p⁺ diffusion layer 21b serving as the emitter region of pnp transistor 40 and p-type diffusion layer 6n serving as the collector region are formed on the main surface of semiconductor substrate 93 so as to interpose field oxide film 7 therebetween.

Here, since a configuration is otherwise approximately similar to that in Embodiment 17 shown in FIG. 10, the same reference characters refer to the same components, and description therefor will not be provided.

In the present embodiment, p⁺ diffusion layer 21a is not formed. Width s3 of the base region of pnp transistor 40, however, can freely be controlled by field oxide film 7. Therefore, by making width s3 smaller than width s4, a configuration in which pnp transistor 40 is more susceptible to punchthrough breakdown than pnp transistor 38 can readily be implemented. Accordingly, the surge protection circuit attaining a normal operation can be formed, and the number of impurity diffusion regions is reduced. The manufacturing process of a semiconductor device is thus simplified.

(Embodiment 13)

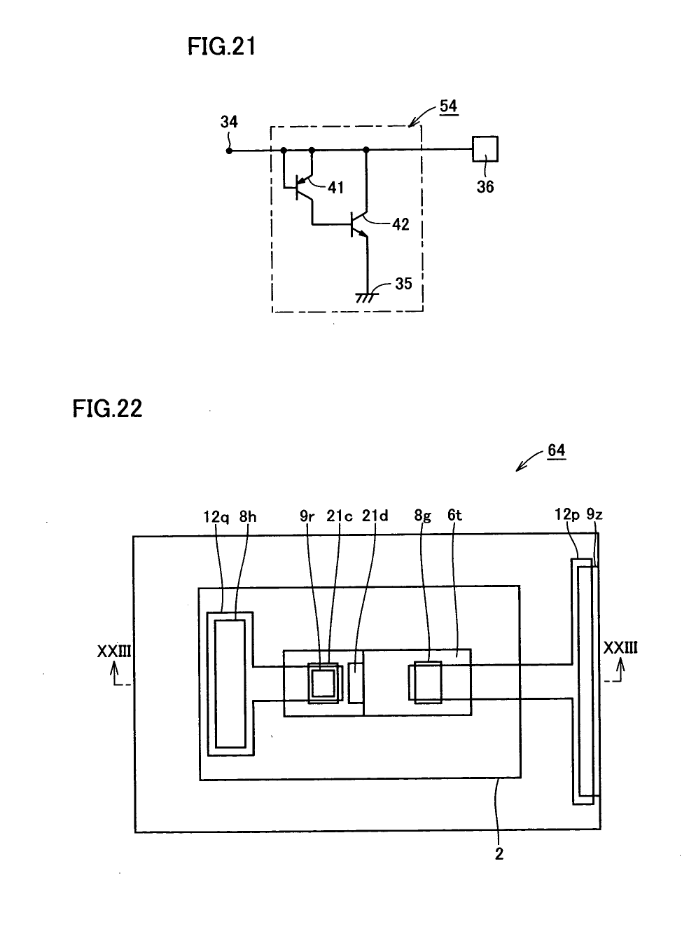

Referring to FIG. 21, a surge protection circuit 54 includes a pnp transistor 41 and an npn transistor 42. A base of pnp transistor 41 and a collector of npn transistor 42 are electrically connected to signal input terminal 34 and device portion 36. The base of pnp transistor 41 is electrically connected to an emitter of pnp transistor 41 and the collector of npn transistor 42. A collector of pnp transistor 41 is electrically connected to a base of npn transistor 42. An emitter of npn transistor 42 is electrically connected to ground potential 35.

Next, a configuration of a semiconductor device with a surge protection circuit in Embodiment 13 will be described.

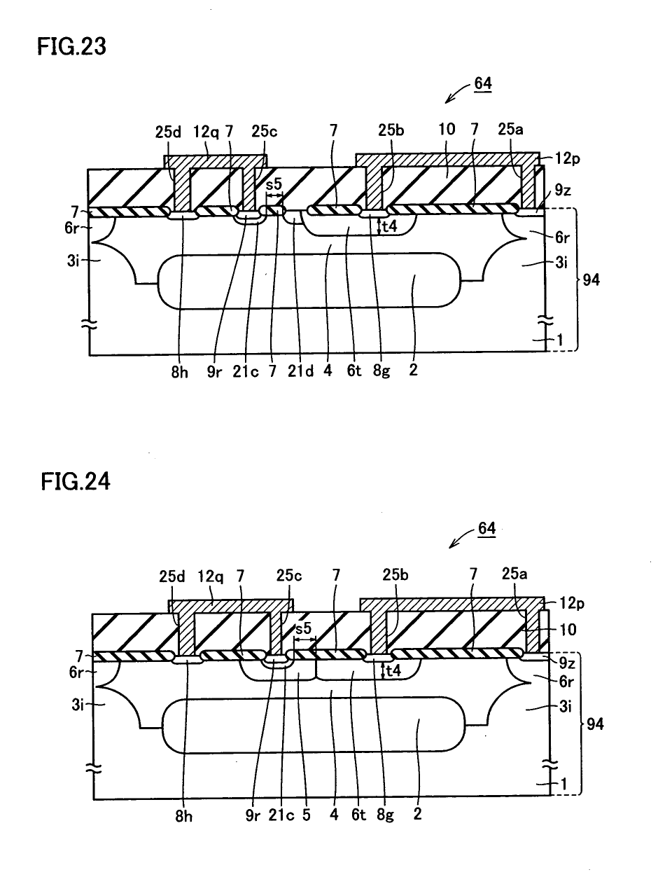

Referring to FIGS. 22 and 23, in a semiconductor device 64, p⁻ region 1 is formed in the lower portion of a semiconductor substrate 94 composed of monocrystalline silicon, for example. On p⁻ region 1, n⁺ diffusion layer 2 is formed by injection and diffusion. N⁻ epitaxial layer 4 is formed on n⁺ diffusion layer 2. A p⁺ diffusion layer 3i and a p-type diffusion layer 6r are formed on p⁻ region 1 so as to surround n⁻ epitaxial layer 4.

In n⁺ diffusion layer 2 and n⁻ epitaxial layer 4, pnp transistor 41 and npn transistor 42 constituting the surge protection circuit are formed. Each of pnp transistor 41 and npn transistor 42 includes the emitter region, the base region, and the collector region.

In pnp transistor 41, the emitter region is constituted with a p⁺ diffusion layer 21c formed in n⁻ epitaxial layer 4, and a p⁺ diffusion layer 9r formed in p⁺ diffusion layer 21c. The base region is constituted with n⁻ epitaxial layer 4 and n⁺ diffusion layer 2. The collector region is constituted with a p⁺ diffusion layer 21d formed in n⁻ epitaxial layer 4, and a p-type diffusion layer 6t formed in n epitaxial layer 4.

In npn transistor 42, the collector region is formed with an n⁺ diffusion layer 8h formed in n⁻ epitaxial layer 4, n⁻ epitaxial layer 4, and n⁺ diffusion layer 2. The base region is constituted with p-type diffusion layer 6t. The emitter region is constituted with an n⁺ diffusion layer 8g formed in p-type diffusion layer 6t.

Thus, p⁺ diffusion layer 21d serving as the collector region of pnp transistor 41 and p-type diffusion layer 6t serving as the base region of npn transistor 42 are formed so as to have the same conductivity type, and are electrically connected to each other. In addition, a junction of p⁺ diffusion layer 21c serving as the emitter region of pnp transistor 41 with n⁻ epitaxial layer 4 serving as the base region of pnp transistor 41 is in contact with one end of field oxide film 7. A pn junction of p⁺ diffusion layer 21d serving as the collector region of pnp transistor 41 with n⁻ epitaxial layer 4 serving as the base region of pnp transistor 41 is in contact with the other end of field oxide film 7.

In this configuration, a narrowest region of the base region of pnp transistor 41 is a region of n⁻ epitaxial layer 4 to the side of p⁺ diffusion layer 21d in the figure, which has a width s5. A narrowest region of the base region of npn transistor 42 is a region of p-type diffusion layer 6t located directly under n⁺ diffusion layer 8g in the figure, which has a width t4. Width s5 is smaller than width t4. In addition, n⁻ epitaxial layer 4 is a region attaining a function as the base of pnp transistor 41, while p-type diffusion layer 6t is a region attaining a function as the base of npn transistor 42.

With a process step identical to the process step in which p⁺ diffusion layer 9r is formed, a p⁺ diffusion layer 9z is formed on the surface of p-type diffusion layer 6r. In addition, with a process step identical to the process step in which n⁺ diffusion layer 8g is formed, n⁺ diffusion layer 8h is formed on the surface of n⁻ epitaxial layer 4. P⁺ diffusion layer 9z; n⁺ diffusion layer 8g; p⁺ diffusion layer 6t and p⁺ diffusion layer 21d; p⁺ diffusion layer 9r; and n⁺ diffusion layer 8h are each electrically isolated by field oxide film 7 formed on the main surface of semiconductor substrate 94.

Interlayer insulating film 10 is formed so as to cover the surface of semiconductor substrate 94. In interlayer insulating film 10, contact holes 25a to 25d are each formed. Accordingly, surfaces of p⁺ diffusion layer 9z, n+diffusion layer 8g, p⁺ diffusion layer 9r, and n⁺ diffusion layer 8h are exposed. Interconnections 12p, 12q composed of doped polysilicon, for example, are formed on interlayer insulating film 10, so as to establish electrical connection with each exposed region described above through each of contacts 25a to 25d. Thus, p⁺ diffusion layer 9z is electrically connected to n⁺ diffusion layer 8g, and p⁺ diffusion layer 9r is electrically connected to n⁺ diffusion layer 8h.

Next, an operation of the surge protection circuit in the present embodiment will be described.

Referring to FIG. 21, when the surge voltage is applied to signal input terminal 34, the voltage between the emitter and the collector of pnp transistor 41 rises, and breakdown occurs in pnp transistor 41. When breakdown occurs in pnp transistor 41, the current flows in the base of npn transistor 42, and npn transistor 42 turns on. When npn transistor 42 turns on, the surge voltage input to signal input terminal 34 is released to ground potential 35 via npn transistor 42. Thus, application of the surge voltage to device portion 36 is prevented.

In the present embodiment, width s5 of the base region of pnp transistor 41 can freely be controlled by field oxide film 7. Therefore, by making width s5 smaller than width t4, a configuration in which pnp transistor 41 is more susceptible to punchthrough breakdown than npn transistor 42 can readily be implemented.

(Embodiment 14)

Referring to FIG. 24, in a semiconductor device in the present embodiment, n-type diffusion layer 5 is formed in n⁻ epitaxial layer 4 formed on the main surface of semiconductor substrate 94. N-type diffusion layer has an impurity density higher than n⁻ epitaxial layer 4. N-type diffusion layer 5 is formed so as to surround p⁺ diffusion layer 21c. N-type diffusion layer 5 and p-type diffusion layer 6t are provided adjacent to each other on the surface within n epitaxial layer 4. In addition, p⁺ diffusion layer 21d is not formed.

In pnp transistor 41, the base region is constituted with n-type diffusion layer 5 formed in n⁻ epitaxial layer 4. The collector region is formed with p-type diffusion layer 6t formed in n⁻ epitaxial layer 4. In this configuration, the narrowest region of the base region of pnp transistor 41 is a region of n-type diffusion layer 5 to the side of p-type diffusion layer 6t in the figure, which has width s5. Width s5 is smaller than width t4. In addition, n-type diffusion layer 5 serves as a region attaining a function as the base of pnp transistor 41. P-type diffusion layer 6t serving as the collector region of pnp transistor 41 and p-type diffusion layer 6t serving as the base region of npn transistor 42 are formed to have the same conductivity type, and are common.

Here, since a configuration is otherwise approximately similar to that in Embodiment 13 shown in FIGS. 21 to 23, the same reference characters refer to the same components, and description therefor will not be provided.

In the present embodiment, n-type diffusion layer 5 serving as the base region of pnp transistor 41 is formed with a region of one conductivity type, and p-type diffusion layer 6t serving as the base region of npn transistor 42 is formed with a region of an opposite conductivity type. Accordingly, by making width s5 of the base of pnp transistor 41 smaller than width t4 of the base of npn transistor 42, pnp transistor 41 is configured so as to be more susceptible to punchthrough breakdown than npn transistor 42. In addition, n-type diffusion layer 5 attaining a function as the base of pnp transistor 41 has an impurity density higher than p-type diffusion layer 6t attaining a function as the base of npn transistor 42. Thus, pnp transistor 41 is configured so as to be more susceptible to avalanche breakdown than npn transistor 42.

In the present embodiment, though a semiconductor device including a circuit in FIGS. 1, 5 and 17 has been described, the present invention is not limited to such an example. Alternatively, a semiconductor device including a surge protection circuit electrically connected to a signal input terminal and having a first transistor and a second transistor would be accepted. In addition, a method of forming an impurity diffusion region is not limited to a condition shown in the present embodiment, but another condition is possible.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A semiconductor device, comprising a surge protection circuit electrically connected to a signal input terminal and having a first transistor and a second transistor; wherein
the semiconductor device is configured such that said first transistor is more susceptible to breakdown than said second transistor, by implementing such a configuration that a narrowest region of a base of said first transistor has a width different from a narrowest region of a base of said second transistor.

2. The semiconductor device according to claim 1, configured such that said first transistor is more susceptible to breakdown than said second transistor, by implementing such a configuration that a region attaining a function as said base of said first transistor has an impurity density different from a region attaining a function as said base of said second transistor.

3. The semiconductor device according to claim 1, wherein
the narrowest region of said base of said first transistor has a width smaller than the narrowest region of said base of said second transistor.

4. The semiconductor device according to claim 1, wherein
in said surge protection circuit, a collector of said first transistor and a collector of said second transistor are electrically connected to said signal input terminal, said base of said first transistor and said base of said second transistor are formed so as to have a same conductivity type, and are electrically connected to each other, and an emitter of said first transistor is electrically connected to said base of said first transistor and said base of said second transistor.

5. The semiconductor device according to claim 1, wherein
said surge protection circuit further includes a resistance element, an emitter of said second transistor and one end of said resistance element are electrically connected to said signal input terminal, said base of said first transistor and a collector of said second transistor are formed so as to have a same conductivity type, and are electrically connected to each other, an emitter of said first transistor is electrically connected to said base of said first transistor and said collector of said second transistor, and a collector of said first transistor is electrically connected to said base of said second transistor and another end of said resistance element.

6. The semiconductor device according to claim 1, wherein
said surge protection circuit further includes resistance element, the emitter of said second transistor and one end of said resistance element are electrically connected to said signal input terminal, said base of said first transistor and said base of said second transistor are formed so as to have a same conductivity type, and are electrically connected to each other, an emitter of said first transistor is electrically connected to said base of said first transistor, said base of said second transistor, and another end of said resistance element, and a collector of said first transistor is electrically connected to a collector of said second transistor.

7. A semiconductor device, comprising a surge protection circuit electrically connected to a signal input terminal and having a first transistor and a second transistor; wherein
the semiconductor device is configured such that said first transistor is more susceptible to breakdown than said second transistor, by implementing such a configuration that a region attaining a function as a base of said first transistor has an impurity density different from that of a region attaining a function as a base of said second transistor.

8. The semiconductor device according to claim 7, wherein
the region attaining a function as said base of said first transistor has an impurity density higher than that of the region attaining a function as said base of said second transistor.

9. A semiconductor device with a surge protection circuit electrically connected to a signal input terminal and having a first transistor and a second transistor, comprising:
a semiconductor substrate having a main surface; and
a field oxide film formed on the main surface of said semiconductor substrate; wherein
an emitter of said first transistor and a collector of said second transistor are electrically connected to said signal input terminal,
a collector of said first transistor and a base of said second transistor are formed so as to have a same conductivity type, and are electrically connected to each other,
a base of said first transistor is electrically connected to said emitter of said first transistor and said collector of said second transistor, and
a pn junction of said emitter and said base of said first transistor is in contact with one end of said field oxide film, and a pn junction of said collector and said base is in contact with another end of said field oxide film.
